(19) United States
(12) Patent Application Publication
(10) Pub. No.: US 2004/0258144 A1
(43) Pub. Date: Dec. 23, 2004

(54) Apparatus for measuring SIR and method of doing the same

(76) Inventor: Youko Omori, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/871,041

(22) Filed: Jun. 21, 2004

(30) Foreign Application Priority Data
Jun. 20, 2003 (JP) 2003-176581

(51) Int. Cl. H04B 1/10

(52) U.S. Cl. 375/224

(57) ABSTRACT

An apparatus for measuring SIR, based on a plurality of symbols obtained from received signals, includes a first unit which controls an averaged-symbol number in accordance with measured SIR, a second unit which calculates signal power, based on the averaged-symbol number of symbols, a third unit which calculates interference power, based on the averaged-symbol number of symbols, and a divider which divides the signal power by the interference power. For instance, the first unit includes a table including correspondence between SIR regions each of which is associated with each SIR, and an averaged-symbol number suitable for measuring each of the SIR regions, and a fourth unit which retrieves the table with the measured SIR to detect an averaged-number symbol associated with SIR region including the measure SIR.

### BACKGROUND OF THE INVENTION

1. Field of the Invention

The invention relates to an apparatus and a method both for measuring a ratio of signal power to interference power in a wide range with high accuracy.

2. Description of the Related Art

In CDMA communication such as IMT-2000, a signal-receiver measures quality of a received signal, and informs the measured quality of a signal-transmitter for controlling signal-transmission power in accordance with the measured quality. For instance, quality of a received signal is expressed as a ratio of signal power to interference power (hereinbelow, referred to simply as “SIR”).

FIG. 1 is a block diagram of a conventional apparatus for measuring SIR. The illustrated apparatus is applied to a digital base band section in a CDMA receiver, and measures SIR based on known pilot signals.

As illustrated in FIG. 1, the conventional apparatus for measuring SIR is comprised of a de-spreader 92, an encoder 93, an in-phase equalizer 94, a first calculator 95 for calculating signal power, a second calculator 96 for calculating interference power, and a divider 97.

The apparatus receives a base band signal (ij, qj) through a signal input terminal 91, and outputs measured SIR through a signal output terminal 98.

The encoder 93 generates a de-spreading code (Ci, Cq), and transmits the de-spreading code to the de-spreader 92.

The de-spreader 92 receives the base signal (ij, qj) through the signal input terminal 91 and the de-spreading code (Ci, Cq) from the encoder 93, and carries out de-spreading process. Specifically, the de-spreader 92 multiplies the base signal (ij, qj) by the de-spreading code (Ci, Cq) to calculate a signal-receipt symbol (Ik, Qk).

The signal-receipt symbol (Ik, Qk) includes not only signal parts (Is, Qs), but also interference parts (nik, nqk). Assuming that the interference parts (nik, nqk) have Gaussian distribution, an average of the interference parts (nik, nqk) is zero (0), and hence, the interference parts (nik, nqk) can be removed by averaging or equalizing them.

The in-phase equalizer 94 averages or equalizes a plurality of the signal-receipt symbols (Ik, Qk) to remove the interference parts (nik, nqk) and extract the signal parts (Is, Qs).

The first calculator 95 calculates a sum of squares of the signal parts (Is, Qs) extracted in the in-phase equalizer 94, as signal power S.

The second calculator 96 calculates dispersion of the signal-receipt symbols (Ik, Qk), based on a plurality of the signal-receipt symbols (Ik, Qk) and the signal power calculated as an average of the signal-receipt symbols (Ik, Qk), as interference power I.

The divider 97 divides the signal power S by the interference power I to calculate SIR.

The conventional apparatus illustrated in FIG. 1 calculates SIR on the assumption that the interference parts (nik, nqk) has Gaussian distribution. As long as the assumption is established, the apparatus can calculate SIR with high accuracy, if it could have a period of time or a number of symbols sufficient to remove the interference parts (nik, nqk).

Japanese Patent Application Publication No. 2002-76989 has suggested an apparatus for measuring SIR with high accuracy by compensating for SIR in accordance with a number of averaged symbols. In the suggested apparatus, a figure determined in accordance with a number of averaged symbols is subtracted from measured SIR for removing an error in averaging symbols.

The conventional apparatus illustrated in FIG. 1 and the apparatus suggested in the above-identified Publication can measure SIR with high accuracy, if SIR to be measured is in such an area as necessary in power transmission control and further as satisfying that interference parts (nik, nqk) can be removed by equalization of symbols.

In recent years, high speed downlink packet access (HSDPA) is being standardized. In HSDPA, adaptive modulation is applied to down-channel signals towards terminals from a base station. Terminals measure SIR of received signals, and inform the base station of measured SIR and an error rate of received packets. The base station switches modulation to another one, based on the measured SIR and the error rate both received from the terminals.

In HSDPA, multiple modulation is carried out to efficiently transmit data for accomplishing high-rate data communication. In order to carry out multiple modulation, it is necessary to reduce interference power. Accordingly, it is necessary in HSDPA to measure SIR in an area in which interference power is small or in an area in which SIR is relatively high, with higher accuracy than an accuracy with which SIR is measured for normal power transmission control.

Hence, an apparatus for measuring SIR is required to measure SIR in a wide range with accuracy in order to apply HSDPA to the apparatus.

In an area in which SIR is high, since interference parts having Gaussian distribution are relatively small, influence by phase-variance becomes relatively high.

A phase difference is generated among a plurality of signal-receipt symbols used for equalization, due to phase-variance in a period of time for equalization, and the phase difference is measured as interference parts. Accordingly, the longer a period of time for equalization is, that is, the greater a number of averaged symbols is, the larger influence caused by phase-variance is. This means that if a number of averaged symbols is made greater for reducing an error in equalization of symbols, an error in interference power caused by phase-variance becomes high.

Hence, in an area in which SIR is relatively high, if measured SIR reaches a predetermined SIR, the measured SIR would not be increased even if interference parts having Gaussian distribution are further suppressed. Accordingly, the conventional apparatus for measuring SIR has a limited area in which SIR can be measured with accuracy, and hence, is not suitable to a communication system to which HSDPA is applied.

Japanese Patent Application Publication No. 2000-252926 has suggested an apparatus for measuring SIR, in which measured SIR is compensated for in accordance with the following equation.

[(N−1)/N]×SIR−1/N

(N: a finite length of a demodulated symbol)

Japanese Patent Application Publication No. 2002-158621 has suggested a method of measuring SIR including the steps of calculating non-centrality of non-central chi-square distribution in a distribution of amplitudes of received signals, and calculating SIR, based on the non-centrality.

Japanese Patent Application Publication No. 2002-246958 has suggested a mobile communication system in which a transmitter adds a common pilot symbol and known series to each of data slots included in a sub-carrier group, and a receiver calculates SIR for each of sub-carrier groups, and then, makes equalization.

Japanese Patent Application Publication No. 2002-290344 has suggested an apparatus for measuring SIR, including first means for separating a received signal including I parts and Q parts, into the I parts and the Q parts, second means for sampling one of the I and Q signals after being de-spread, and storing a distribution of signal amplitudes, third means for calculating sample average and sample dispersion, based on the distribution of signal amplitudes, and fourth means for squaring the sample average to have signal power and squaring the sample dispersion to have interference power, and calculating SIR, based on the thus calculated signal and interference powers.

Japanese Patent Application Publication No. 10-190497 has suggested an apparatus for measuring SIR, including first means for converting a received signal including I parts and Q parts, into signals in a first quadrant in I-Q coordinate system, and squaring an average of the signals to thereby have first average power, second means for calculating an average of square of received signals as second average power, third means for subtracting the first average power from the second average power to thereby have interference power, and fourth means for calculating SIR by dividing the first average power by the interference power.

### SUMMARY OF THE INVENTION

In view of the above-mentioned problems in the prior art, it is an object of the present invention to provide an apparatus for measuring SIR in a wide range with high accuracy and a method of doing the same.

Hereinbelow is described the apparatus and method in accordance with the present invention through the use of reference numerals used in later described embodiments. The reference numerals are indicated only for the purpose of clearly showing correspondence between claims and the embodiments. It should be noted that the reference numerals are not allowed to interpret of claims of the present application.

In one aspect of the present invention, there is provided an apparatus for measuring SIR, based on a plurality of symbols obtained from received signals, including (a) a first unit (19, 39) which controls an averaged-symbol number in accordance with measured SIR, (b) a second unit (14, 15; 34, 35) which calculates signal power, based on the averaged-symbol number of symbols, (c) a third unit (16, 36) which calculates interference power, based on the averaged-symbol number of symbols, and (d) a divider (17, 37) which divides the signal power by the interference power.

In the apparatus in accordance with the present invention, the first unit compensates for a number of averaged-symbols to be used in the second and third units, in accordance with measured SIR, ensuring an appropriate number of signal-receipt symbols in a wide range of SIR.

For instance, the first unit (19) may be designed to include (a1) a table (21) including correspondence between SIR regions each of which is associated with each SIR, and an averaged-symbol number suitable (21) for measuring SIR in each of the SIR regions, and (a2) a fourth unit (20) which retrieves the table (21) with the measured SIR to detect an averaged-number symbol associated with SIR region including the measure SIR.

The first unit (19) may be designed to select an averaged-symbol number to remove Gaussian distribution parts by equalization for SIR region in which interference parts having Gaussian distribution are predominant, and selects an averaged-symbol number to remove influence caused by phase-variance for SIR region in which phase-variance is predominant.

An averaged-symbol number to remove interference parts by equalization thereof is selected for SIR region in which interference parts having Gaussian distribution are predominant, and an averaged-symbol number to remove influence caused by phase-variance is selected for SIR region in which phase-variance is predominant. Thus, the apparatus can measure SIR both in an area in which SIR is relatively low and an area in which SIR is relatively high.

The first unit (39) may be designed to include (a) a fifth unit (41) which calculates standard deviation (δ_{SIR}) of the measured SIR, and (b) a sixth unit (40) which controls an averaged-symbol number (M) in accordance with the standard deviation (δ_{SIR}).

The first unit (39) may be designed to increase the averaged-symbol number (M) if the standard deviation (δ_{SIR}) is equal to or greater than a predetermined threshold (δt), and reduce the averaged-symbol number (M) if the standard deviation (δ_{SIR}) is smaller than the predetermined threshold (δt).

In an area in which SIR is relatively low, that is, SIR has much variance, and hence, the standard deviation thereof is equal to or greater than a predetermined threshold, the averaged-symbol number is increased for raising accuracy with which interference parts are averaged, and in an area in which SIR is relatively high, that is, SIR has small variance, and hence, the standard deviation thereof is smaller than the predetermined threshold, the averaged-symbol number is reduced for reducing influence caused by phase-variance. Thus, the apparatus can measure SIR both in an area in which SIR is relatively low and an area in which SIR is relatively high.

The first unit (39) may be designed to control the averaged-symbol number (M) between an upper limit (Mmax) and a lower limit (Min).

By selecting upper and lower limits in accordance with requirements, the apparatus can measure SIR with the requirements being satisfied.

In another aspect of the present invention, there is provided a method of measuring SIR, based on a plurality of symbols obtained from received signals, including (a) controlling an averaged-symbol number in accordance with measured SIR, (b) calculating signal power, based on the averaged-symbol number of symbols, (c) calculating interference power, based on the averaged-symbol number of symbols, and (d) dividing the signal power by the interference power to calculate the measured SIR.

The method may further include (e) preparing a table (21) including correspondence between SIR regions each of which is associated with each SIR, and an averaged-symbol number suitable (21) for measuring SIR in each of the SIR regions, and (f) retrieving the table (21) with the measured SIR to detect an averaged-number symbol associated with SIR region including the measure SIR.

In the method, an averaged-symbol number may be selected in the step (a) to remove Gaussian distribution parts by equalization for SIR region in which interference parts having Gaussian distribution parts are predominant, and an averaged-symbol number may be selected in the step (a) to remove influence caused by phase-variance for SIR region in which phase-variance is predominant.

It is preferable that the step (a) includes (a1) calculating standard deviation of the measured SIR, and (a2) controlling an averaged-symbol number in accordance with the standard deviation.

It is preferable that the averaged-symbol number is increased if the standard deviation is equal to or greater than a predetermined threshold, and the averaged-symbol number is reduced if the standard deviation is smaller than the predetermined threshold, in the step (a2).

It is preferable that the averaged-symbol number is controlled between an upper limit and a lower limit in the step (a2).

The advantages obtained by the aforementioned present invention will be described hereinbelow.

In the apparatus in accordance with the present invention, the first unit compensates for a number of averaged-symbols to be used in the second and third units, in accordance with measured SIR, ensuring an appropriate number of signal-receipt symbols in a wide range of SIR. Thus, the apparatus can measure SIR with high accuracy.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a conventional apparatus for measuring SIR.

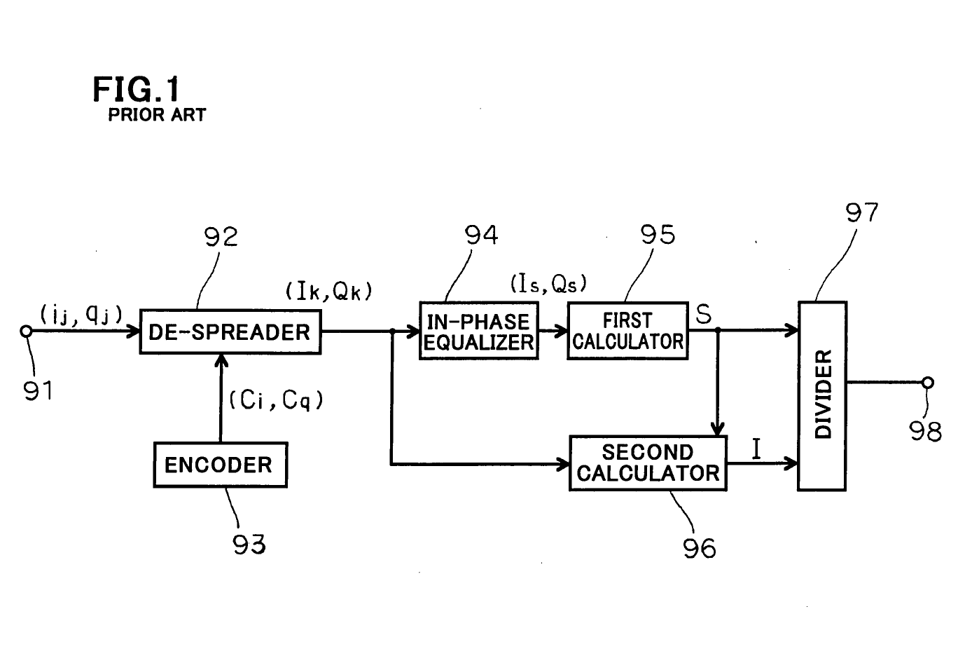

FIG. 2 is a block diagram of an apparatus for measuring SIR, in accordance with the first embodiment of the present invention.

FIG. 3 is a block diagram of an apparatus for measuring SIR, in accordance with the second embodiment of the present invention.

FIG. 4 is a flow-chart showing an operation of the sixth unit in the apparatus in accordance with the second embodiment of the present invention.

### DESCRIPTION OF THE PREFERRED EMBODIMENTS

Preferred embodiments in accordance with the present invention will be explained hereinbelow with reference to drawings.

[First Embodiment]

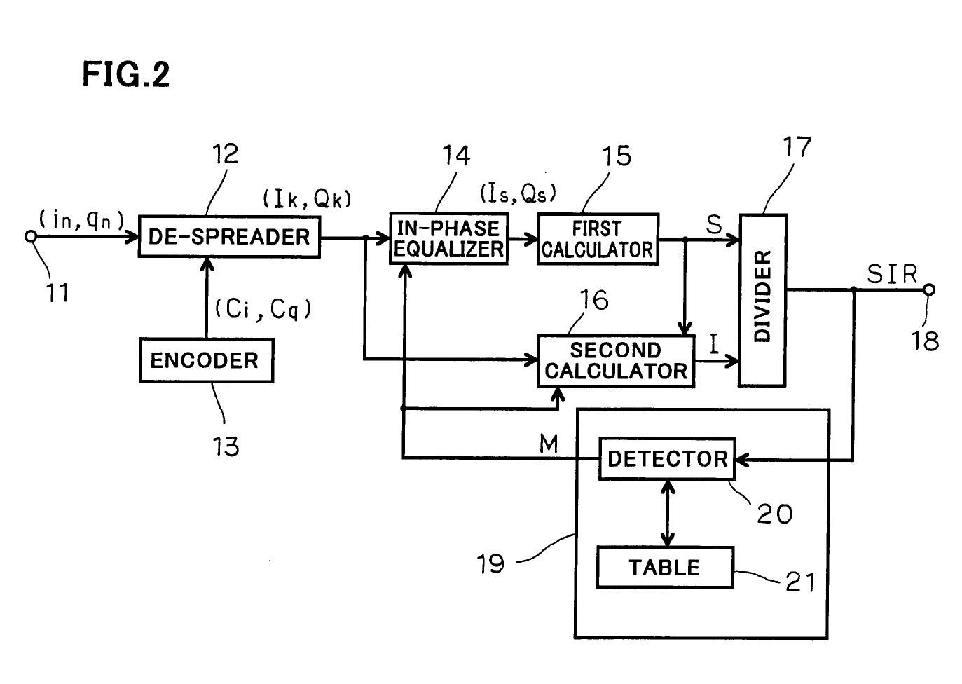

FIG. 2 is a block diagram for measuring SIR, in accordance with the first embodiment of the present invention.

The apparatus is applied to a digital base band section in a CDMA signal-receiver.

As illustrated in FIG. 2, the apparatus is comprised of a de-spreader 12, an encoder 13, an in-phase equalizer 14, a first calculator 15 for calculating signal power, a second calculator 16 for calculating interference power, a divider 17, and a first unit 19.

The first unit 19 controls a number of symbols, and is comprised of a detector 20 and a table 21.

The apparatus receives a base band signal (in, qn) through a signal input terminal 11, and outputs measured SIR through a signal output terminal 18.

The encoder 13 generates a de-spreading code (Ci, Cq), and transmits the de-spreading code (Ci, Cq) to the de-spreader 12.

The de-spreader 12 receives the base signal (in, qn) through the signal input terminal 11 and the de-spreading code (Ci, Cq) from the encoder 13, and carries out de-spreading process. Specifically, the de-spreader 12 multiplies the base signal (in, qn) by the de-spreading code (Ci, Cq), and further integrates the products in accordance with a spreading rate to calculate a signal-receipt symbol (Ik, Qk).

The in-phase equalizer 14 averages or equalizes M signal-receipt symbols (Ik, Qk) wherein M indicates a number of averaged symbols, to remove interference parts (nik, nqk) and extract the signal parts (Is, Qs). The averaged-symbol number M is transmitted to the in-phase equalizer 14 from the detector 20.

The first calculator 15 calculates a sum of squares of the signal parts (Is, Qs) extracted in the in-phase equalizer 14, as signal power S.

The second calculator 16 calculates dispersion of the signal-receipt symbols (Ik, Qk), based on M signal-receipt symbols (Ik, Qk) and the signal power S calculated as an average of the M signal-receipt symbols (Ik, Qk), as interference power I.

The divider 17 divides the signal power S by the interference power I to calculate SIR.

The table 21 stores therein correspondence between SIR regions each of which is associated with each SIR, and a number of averaged symbols suitable for measuring SIR in each of the SIR regions. In a relatively low SIR region in which interference parts having Gaussian distribution parts are predominant, a number of averaged symbols is selected to remove the interference parts by equalizing the interference parts in the in-phase equalizer 14. In a relatively high SIR region in which influence caused by phase-variance is predominant, a number of averaged symbols is selected to reduce the influence.

The detector 20 retrieves the table 21, based on SIR transmitted from the divider 17, and detects a number of averaged symbols associated with the SIR. Then, the detector 20 transmits the detected number of averaged symbols to the in-phase equalizer 14 and the second calculator 16.

Hereinbelow is explained an operation of the apparatus for measuring SIR, in accordance with the first embodiment.

The de-spreader 12 calculates the signal-receipt symbol (Ik, Qk) in accordance with the following equations (1) and (2).

$$\begin{matrix}{I}_{k} = {\sum }_{n = 0}^{Sf - 1} ( {i}_{n} \times {c}_{in} - {q}_{n} \times {c}_{qn} ) & ( 1 ) \\ {Q}_{k} = {\sum }_{n = 0}^{Sf - 1} ( {i}_{n} \times {c}_{qn} + {q}_{n} \times {c}_{in} ) & ( 2 )\end{matrix}$$

In the equations (1) and (2), “Sf” indicates a spreading rate. The signal-receipt symbol (Ik, Qk) includes not only signal parts (Is, Qs), but also interference parts (nik, nqk). The parts Ik and Qk of the signal-receipt symbol are expressed in accordance with the equations (3) and (4).

Iₖ=Iₛ+nᵢₖ (3)

Qₖ=Qₛ+n_{qk} (4)

Then, the in-phase equalizer 14 equalizes the parts Ik and Qk of the signal-receipt symbol with the number M of averaged symbols in accordance with the following equations (5) and (6).

$$\begin{matrix}\hat{I} = \frac{1}{M} {\sum }_{k = 0}^{M - 1} {I}_{k} & ( 5 ) \\ \hat{Q} = \frac{1}{M} {\sum }_{k = 0}^{M - 1} {Q}_{k} & ( 6 )\end{matrix}$$

Each of the left sides in the equations (5) and (6) indicates an equalized signal-part.

Then, the first calculator 15 calculates the signal power S in accordance with the equation (7).

S=(\hat{I})+(\hat{Q})² (7)

The second calculator 16 calculates the interference power I in accordance with the equation (8). As indicated in the equation (8), the interference power I is given as dispersion of M signal-receipt symbols (Ik, Qk).

$$I = \frac{1}{M - 1} ( {\sum }_{k = 0}^{M - 1} ( {I}_{k}^{2} + {Q}_{k}^{2} ) - S ) \qquad ( 8 )$$

Then, the divider 17 calculates SIR by dividing the signal power S having been calculated by the first calculator 15 by the interference power I having been calculated by the second calculator 16 in accordance with the equation (9).

SIR=S/I (9)

The detector 20 in the first unit 19 receives the thus calculated SIR from the divider 17, and retrieves the table 21, based on the received SIR, to detect a number of averaged symbols associated with the SIR. Then, the detector 20 transmits the detected number of averaged symbols to the in-phase equalizer 14 and the second calculator 16.

Thus, the in-phase equalizer 14 and the second calculator 16 use the number of averaged symbols in the calculation. As a result, SIR can be measured with enhanced accuracy.

In accordance with the apparatus, the first unit 19 selects a number of averaged symbols to remove the interference parts having Gaussian distribution by equalizing the interference parts in a relatively low SIR region in which the interference parts having Gaussian distribution are predominant, and selects a number of averaged symbols to reduce influence caused by phase-variance in a relatively high SIR region in which phase-variance is predominant. The in-phase equalizer 14 and the first calculator 15 calculate the signal power S, based on the number M of averaged symbols, and the second calculator 16 calculates the interference power I, based on the number M of averaged symbols. The divider 17 calculates SIR, based on the signal power S and the interference power I. Thus, the apparatus in accordance with the first embodiment can measure SIR both in an area in which SIR is relatively low and an area in which SIR is relatively high.

There may be used SIR and a current number of averaged symbols as parameters for calculating a new number of averaged symbols. By estimating influence caused by phase-variance, based on a current number of averaged symbols, it would be possible to accurately know a relation between interference parts having Gaussian distribution and influence caused by phase-variance.

[Second Embodiment]

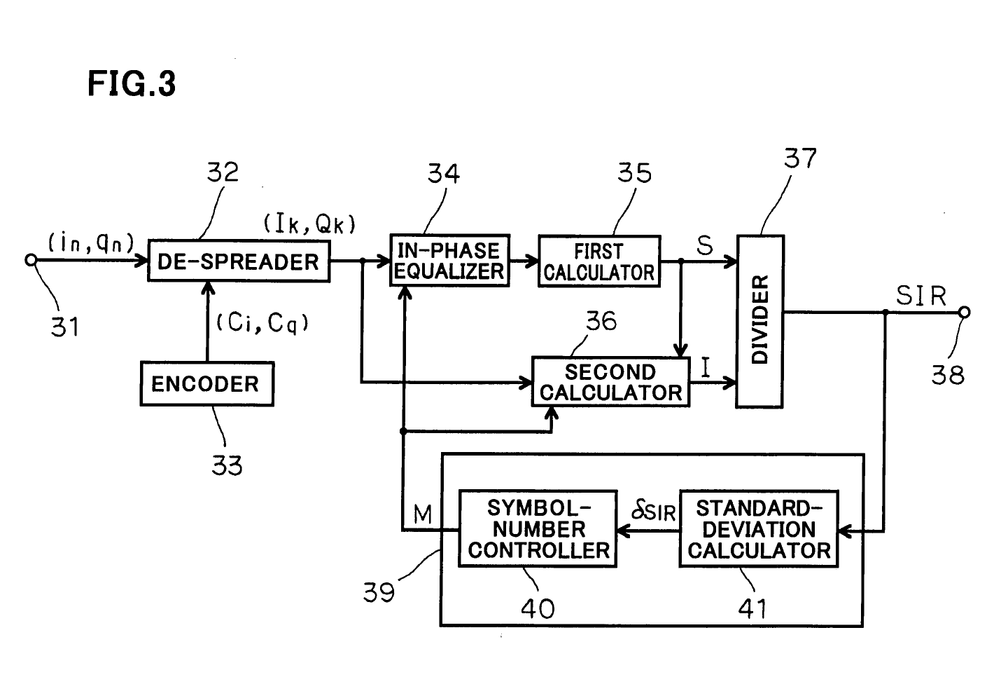

FIG. 3 is a block diagram for measuring SIR, in accordance with the second embodiment of the present invention.

The apparatus is applied to a digital base band section in a CDMA signal-receiver.

As illustrated in FIG. 3, the apparatus is comprised of a de-spreader 32, an encoder 33, an in-phase equalizer 34, a first calculator 35 for calculating signal power, a second calculator 36 for calculating interference power, a divider 37, and a first unit 39.

The first unit 39 controls a number of symbols, and is comprised of a symbol-number controller 40 and a standard-deviation calculator 41.

The apparatus receives a base band signal (in, qn) through a signal input terminal 31, and outputs measured SIR through a signal output terminal 38.

The encoder 33 generates a de-spreading code (Ci, Cq), and transmits the de-spreading code (Ci, Cq) to the de-spreader 32.

The de-spreader 32 receives the base signal (in, qn) through the signal input terminal 31 and the de-spreading code (Ci, Cq) from the encoder 33, and carries out de-spreading process. Specifically, the de-spreader 32 multiplies the base signal (in, qn) by the de-spreading code (Ci, Cq), and further integrates the products in accordance with a spreading rate to calculate a signal-receipt symbol (Ik, Qk).

The in-phase equalizer 34 averages or equalizes M signal-receipt symbols (Ik, Qk) wherein M indicates a number of averaged symbols, to remove interference parts (nik, nqk) and extract the signal parts (Is, Qs). The averaged-symbol number M is transmitted to the in-phase equalizer 34 from the symbol-number controller 40 of the first unit 39.

The first calculator 35 calculates a sum of squares of the signal parts (Is, Qs) extracted in the in-phase equalizer 34, as signal power S.

The second calculator 36 calculates dispersion of the signal-receipt symbols (Ik, Qk), based on M signal-receipt symbols (Ik, Qk) and the signal power S calculated as an average of the M signal-receipt symbols (Ik, Qk), as interference power I.

The divider 37 divides the signal power S by the interference power I to calculate SIR.

The standard-deviation calculator 41 calculates standard deviation δ_{SIR} of SIR having been calculated in the divider 37. The standard deviation δ_{SIR} indicates a variance of measured SIRS, and further indicates accuracy in equalization of SIRS. In other words, the standard deviation δ_{SIR} indicates whether a number M of averaged symbols is an appropriate number. For instance, a high standard deviation δ_{SIR} indicates insufficient accuracy in equalization. That is, a high standard deviation δ_{SIR} indicates that interference parts having Gaussian distribution is not well removed, and hence, a number M of averaged symbols is not appropriate.

The symbol-number controller 40 controls a number M of averaged symbols in accordance with the standard deviation δ_{SIR} of SIR having been calculated in the standard-deviation calculator 41.

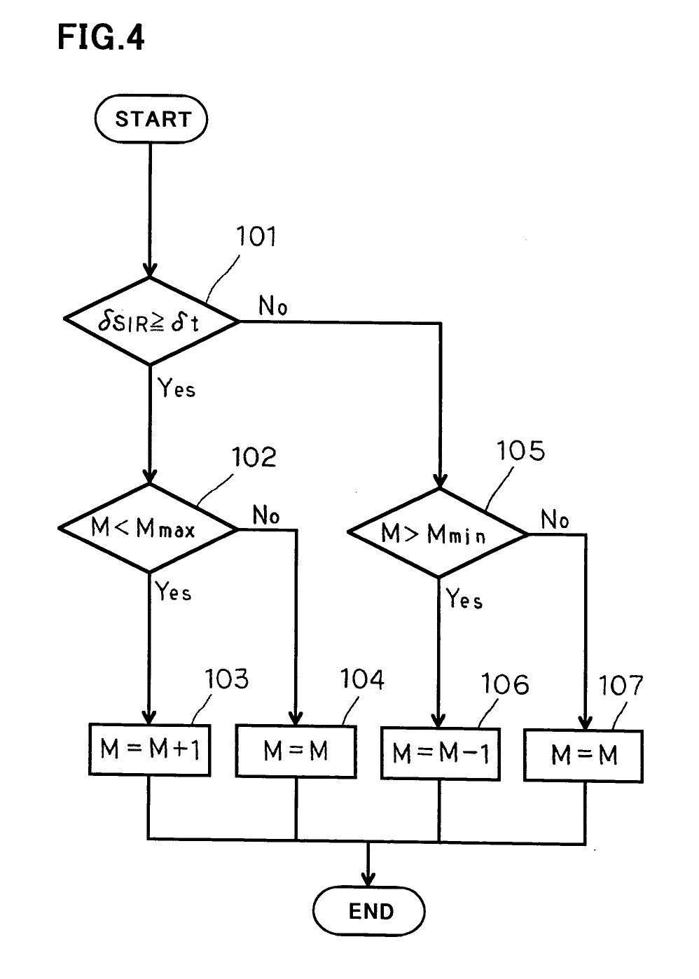

FIG. 4 is a flow-chart showing an operation of the symbol-number controller 40.

With reference to FIG. 4, the symbol-number controller 40 judges whether the standard deviation δ_{SIR} of SIR is equal to or greater than a predetermined threshold δt, in step 101.

If the standard deviation δ_{SIR} of SIR is equal to or greater than the threshold δt (YES in step 101), the symbol-number controller 40 judges whether a number M of averaged symbols is smaller than a maximum number Mmax of symbols, in step 102.

If a number M of averaged symbols is smaller than a maximum number Mmax of symbols (YES in step 102), the symbol-number controller 40 adds one (1) to a number M of averaged symbols, in step 103.

If a number M of averaged symbols is equal to or greater than a maximum number Mmax of symbols (NO in step 102), the symbol-number controller 40 keeps a number M of averaged symbols unchanged, in step 104.

If the standard deviation δ_{SIR} of SIR is smaller than the threshold δt (NO in step 101), the symbol-number controller 40 judges whether a number M of averaged symbols is greater than a minimum number Mmin of symbols, in step 105.

If a number M of averaged symbols is greater than a minimum number Mmin of symbols (YES in step 105), the symbol-number controller 40 subtracts one (1) from a number M of averaged symbols, in step 106.

If a number M of averaged symbols is equal to or smaller than a minimum number Mmin of symbols (NO in step 105), the symbol-number controller 40 keeps a number M of averaged symbols unchanged, in step 107.

If the standard deviation δ_{SIR} of SIR is small, that is, a variance of SIR is small, it would be possible to equalize interference parts with high accuracy by a small number M of averaged symbols. In contrast, if the standard deviation δ_{SIR} of SIR is high, that is, a variance of SIR is high, it would not be possible to equalize interference parts with high accuracy unless a number M of averaged symbols is increased.

The symbol-number controller 40 increases a number M of average symbols, if the standard deviation δ_{SIR} of SIR is equal to or greater than the threshold δt, that is, accuracy at which equalization of interference parts is carried out is low, and reduces a number M of average symbols, if the standard deviation δ_{SIR} of SIR is smaller than the threshold δt, that is, accuracy at which equalization of interference parts is carried out is high.

The above-mentioned maximum number Mmax of symbols indicates an upper limit of the number M of averaged symbols. The apparatus for measuring SIR has a range of measurement, and hence, is not necessary to be able to measure SIR beyond the range. The maximum number Mmax of symbols is determined in order to prevent the number M of averaged symbols from becoming too large, when SIR is quite small.

The above-mentioned minimum number Mmin of symbols indicates a lower limit of the number M of averaged symbols. If the number M of averaged symbols is equal to zero (0) or one (1), calculation cannot be made in accordance with the above-mentioned equations (5), (6) and (8). Furthermore, if the number M of averaged symbols is too small, it would not be possible to measure SIR with high accuracy because of an error in equalization of interference parts. Thus, in order to ensure a desired accuracy, there is determined a minimum number Mmin of symbols.

The threshold δt, the maximum number Mmax of symbols, and the minimum number Mmin of symbols may be parameters to be determined, based on requirements such as a range of SIR to be measured, a requisite accuracy with which SIR is measured, conditions of radio signals, a capacity of an apparatus for measuring SIR, and so on.

As having been explained above, in accordance with the second embodiment, the first unit 39 increases a number M of averaged symbols to enhance accuracy with which interference parts are equalized, if SIR is relatively low, that is, the standard deviation δ_{SIR} of SIR is equal to or greater than the threshold δt, and lowers a number M of averaged symbol to reduce influence caused by phase-variance, if SIR is relatively high, that is, the standard deviation δ_{SIR} of SIR is smaller than the threshold δt. Thus, the apparatus can measure SIR with high accuracy both in an area in which SIR is relatively low and an area in which SIR is relatively high.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2003-176581 filed on Jun. 20, 2003 including specification, claims, drawings and summary is incorporated herein by reference in its entirety.

What is claimed is:

1. An apparatus for measuring SIR, based on a plurality of symbols obtained from received signals, comprising:
(a) a first unit which controls an averaged-symbol number in accordance with measured SIR;
(b) a second unit which calculates signal power, based on the averaged-symbol number of symbols;
(c) a third unit which calculates interference power, based on the averaged-symbol number of symbols; and
(d) a divider which divides said signal power by said interference power.

2. The apparatus as set forth in claim 1, wherein said first unit includes:
(a1) a table including correspondence between SIR regions each of which is associated with each SIR, and an averaged-symbol number suitable for measuring SIR in each of said SIR regions; and
(a2) a fourth unit which retrieves said table with said measured SIR to detect an averaged-number symbol associated with SIR region including said measure SIR.

3. The apparatus as set forth in claim 1, wherein said first unit selects an averaged-symbol number to remove Gaussian distribution parts by equalization for SIR region in which interference parts having Gaussian distribution parts are predominant, and selects an averaged-symbol number to remove influence caused by phase-variance for SIR region in which phase-variance is predominant.

4. The apparatus as set forth in claim 1, wherein said first unit includes:
(a) a fifth unit which calculates standard deviation of said measured SIR; and
(b) a sixth unit which controls an averaged-symbol number in accordance with said standard deviation.

5. The apparatus as set forth in claim 4, wherein said first unit increases said averaged-symbol number if said standard deviation is equal to or greater than a predetermined threshold, and reduces said averaged-symbol number if said standard deviation is smaller than said predetermined threshold.

6. The apparatus as set forth in claim 5, wherein said first unit controls said averaged-symbol number between an upper limit and a lower limit.

7. A method of measuring SIR, based on a plurality of symbols obtained from received signals, comprising:
(a) controlling an averaged-symbol number in accordance with measured SIR;
(b) calculating signal power, based on the averaged-symbol number of symbols;
(c) calculating interference power, based on the averaged-symbol number of symbols; and
(d) dividing said signal power by said interference power to calculate said measured SIR.

8. The method as set forth in claim 7, further comprising:
(e) preparing a table including correspondence between SIR regions each of which is associated with each SIR, and an averaged-symbol number suitable for measuring SIR in each of said SIR regions; and
(f) retrieving said table with said measured SIR to detect an averaged-number symbol associated with SIR region including said measure SIR.

9. The method as set forth in claim 7, an averaged-symbol number is selected in said step (a) to remove Gaussian distribution parts by equalization for SIR region in which interference parts having Gaussian distribution parts are predominant, and an averaged-symbol number is selected in said step (a) to remove influence caused by phase-variance for SIR region in which phase-variance is predominant.

10. The method as set forth in claim 7, wherein said step (a) includes:
(a1) calculating standard deviation of said measured SIR; and
(a2) controlling an averaged-symbol number in accordance with said standard deviation.

11. The method as set forth in claim 10, wherein said averaged-symbol number is increased if said standard deviation is equal to or greater than a predetermined threshold, and said averaged-symbol number is reduced if said standard deviation is smaller than said predetermined threshold, in said step (a2).

12. The method as set forth in claim 11, wherein said averaged-symbol number is controlled between an upper limit and a lower limit in said step (a2).
